(19) United States
(12) Patent Application Publication
(10) Pub. No.: US 2009/0241195 A1
(43) Pub. Date: Sep. 24, 2009

(54) DEVICE AND METHOD FOR PREVENTING VIRUS INFECTION OF HARD DISK

(75) Inventors: Chien-Ping Chung, Taipei (TW); Chingfu Chuang, Taipei (TW)

Correspondence Address: KIRTON AND MCCONKIE, 60 EAST SOUTH TEMPLE,, SUITE 1800, SALT LAKE CITY, UT, 84111, US

(73) Assignee: ASMEDIA TECHNOLOGY INC., Taipei (TW)

(21) Appl. No.: 12/238,823

(22) Filed: Sep. 26, 2008

(30) Foreign Application Priority Data
Mar. 18, 2008 (TW) 097109506

(51) Int. Cl. G06F 21/00

(52) U.S. Cl. 726/24

(57) ABSTRACT

A device and a method for preventing virus infection of a hard disk are provided. The virus infection preventing device includes a storage media, a read-only memory, a control circuit and a switch. The virus infection preventing method includes steps of generating either a first signal or a second signal by a switch, and receiving a write command. If the write command allows data to be written into a boot sector of the hard disk and the first signal is generated by the switch, the write command is aborted. Whereas, if the write command allows data to be written into the boot sector of the hard disk and the second signal is generated by the switch, the write command is executed.

### FIELD OF THE INVENTION

The present invention relates to a device and a method for preventing virus infection of a hard disk, and more particularly to device and a method for preventing the hard disk from being infected by boot strap sector viruses.

### BACKGROUND OF THE INVENTION

A computer virus is a computer program that can causes unexpected and usually undesirable events within a computer system. Depending on the infected sites, computer viruses are generally classified into five major types: file infector viruses, boot strap sector viruses, multi-partite viruses, macro viruses and Windows viruses.

A file infector virus is one of the most common computer viruses. A file infector virus typically attaches itself to an executable file of a program. When a program infected with a file infector virus is running, the virus copies the infection code to other executable programs on the computer system. An example of a file infector virus is the Connie virus or the Jerusalem virus.

A multi-partite virus has combined characteristics of both the file infector virus and the boot strap sector virus. Since the multi-partite virus can infect both the boot sector and files on the computer system, the rate of spread of this type of virus is very high. In other words, this type of virus can infect no only the .exe or .com files but also the boot sectors of disks or hard disks. In a case that the multi-partite virus infects the boot sector when the computer system is boosted, it will in turn infect the programs and the files that have been executed. This type of virus can re-infect the computer system over and over again if all parts of the virus are not eradicated. An example of a multi-partite virus is the Hammer that has been widespread in Taiwan or the Flip virus hat has been widespread in Europe.

A macro virus is a new type of virus that is written in a macro language. Since some applications allow macro programs to be embedded in documents, the programs may be run automatically when the document is opened. The macro virus can infect document files, most commonly Microsoft Word or Excel, but it can infect any data file or document template file. When an infected document file is opened, the viral macro code copies itself to the default document template and thus the virus spread to any document opened using the computer system. An example of a macro virus is the Taiwan NO. 1 Word virus that has been widespread in Taiwan.

The infecting mechanisms of the Windows viruses are substantially identical to the file infector viruses except that the Windows viruses attack files under the Windows environment.

A boot strap sector virus typically infects the system boot area of a disk or a hard disk that is used by a computer during boot up. As such, the boot strap sector virus is also call as a system virus. The boot strap sector virus typically conceals itself in or infects a first sector (i.e. the boot sector) of a disk or a hard disk. The most common way a boot virus spreads is by starting a computer with an infected disk. When the computer is looking for the boot information, the boot strap sector virus is transferred to the memory. As such, the boot strap sector virus can infect the operating system on every startup of the computer. If the boot strap sector virus has infected the computer, the boot strap sector virus has a stronger capability to propagate itself to other computers. Generally, the boot strap sector viruses are classified into two sub-types, i.e. a traditional boot strap sector virus and a stealth boot virus. The traditional boot strap sector virus is written into the boot sectors of a floppy disk and is spread by starting a computer with the infected disk. An example of a traditional boot strap sector virus is the Michelangelo virus (or the Stoned virus). The stealth boot virus can infect a boot sector of a hard disk. The stealth boot virus tries to trick anti-virus software by forging the boot sector. The stealth boot virus can induce the serious destruction of data in the hard disk on the next startup of the computer. That is to say, the boot strap sector virus typically destroys the boot sector of the computer hard disk so as to spread itself and destroy the whole system. Since the effective boot sector is located in the first sector (LBA=0 or CHS=0:0:1), the boot strap sector virus will induce serious damage of the whole system if the boot sector is rewritten.

In order to reduce the hard disk damage resulting from virus infection, a typical way is to employ anti-virus software to detect whether the boot sector is abnormally written and issue a warning message to notify the user. Since the virus type is unceasingly changed and new viruses are increasingly created, some loopholes may be exploited by the viruses and these viruses could not be detected by any powerful anti-virus software. In addition, the attacker may produce a program to attack the loophole of the anti-virus software and thus the anti-virus software is infected by the viruses. Once the anti-virus software is infected, the anti-virus software not only loses the function of identifying or eliminating malicious software but is also programmed to treat as a virus. If the detection mechanism of the anti-virus software is unlocked, the anti-virus software will not perform a virus-scanning operation when the malicious software tries to open a malicious file. On the contrary, the program contained in the malicious file is executed. Under this circumstance, the anti-virus software is unable to combat computer viruses but causes the viruses to infect the hard disk.

FIG. 1 is a flowchart 20 for preventing virus infection of a hard disk has been disclosed. First of all, the computer system is powered on and started (Step 21). Next, the function of the basic input/output system (BIOS) of the computer system is executed and a self-test diagnostics is run (Step 22). Next, the computer system will read a bootstrap procedure of a boot sector (Step 23). If the boot sector is modified (Step 24), a boot sector virus warning signal is issued (Step 26). Otherwise, the bootstrap procedure is performed (Step 25).

As previously described, anti-virus software is employed to detect whether the boot sector is modified during the computer system is booted (in Step 24). In a case that the boot sector is modified, the boot sector virus warning signal is issued. Whereas, in another case that the detecting result shows no boot sector has been modified, the boot procedure is continuously done. The above virus detection method, however, still has some drawbacks. For example, if the loopholes of the anti-virus software are exploited by viruses, the viruses will infect the boot sector of the hard disk because the anti-virus software discriminates a normal operation of the boot sector. Under this circumstance, the viruses can induce the serious destruction of data in the hard disk. Once the anti-virus software is infected, the anti-virus software will lose the function of identifying or eliminating malicious software. If the detection mechanism of the anti-virus software is unlocked, the anti-virus software will not perform a virus-scanning operation when the malicious software tries to open a malicious file.

Another approach for preventing virus infection of a hard disk uses firmware to detect computer viruses. In addition, a hard disk is divided into several partitions. Each of these partitions is made up of logically consecutive sectors. The partitions for storing data and the infected partitions are separated. Since the infected partitions may be independently treated, the problem of losing data is avoided. This approach, however, still fails to effectively prevent virus infection of hard disk.

From the above discussions, the use of software fails to effectively prevent virus infection of hard disk because some loopholes of the software may be exploited by viruses.

Therefore, there is a need of providing device and a method for preventing virus infection of a hard disk so as to obviate the drawbacks encountered from the prior art.

### SUMMARY OF THE INVENTION

The present invention relates to a device and a method for preventing virus infection of a hard disk, and more particularly to device and a method for preventing the hard disk from being infected by boot strap sector viruses

In accordance with an aspect of the present invention, the method for preventing virus infection of a hard disk includes steps of generating either a first signal or a second signal by a switch, receiving a write command, and aborting the write command if the write command allows data to be written into a boot sector of the hard disk and the first signal is generated by the switch, or executing the write command if the write command allows data to be written into the boot sector of the hard disk and the second signal is generated by the switch.

In accordance with another aspect of the present invention, the device for preventing virus infection of a hard disk includes a storage media, a read-only memory, a control circuit and a switch. The read-only memory stores a firmware therein. The control circuit is communicated with the read-only memory and the storage media and manipulated by the firmware. The switch is communicated with the control circuit for issuing either a first signal or a second signal to the control circuit. If a write command received by the control circuit allows data to be written into a boot sector of the storage media and the first signal is generated by the switch, the write command is aborted. Whereas, if the write command allows data to be written into the boot sector of the storage media and the second signal is generated by the switch, the write command is executed.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a flowchart for preventing virus infection of a hard disk has been disclosed;

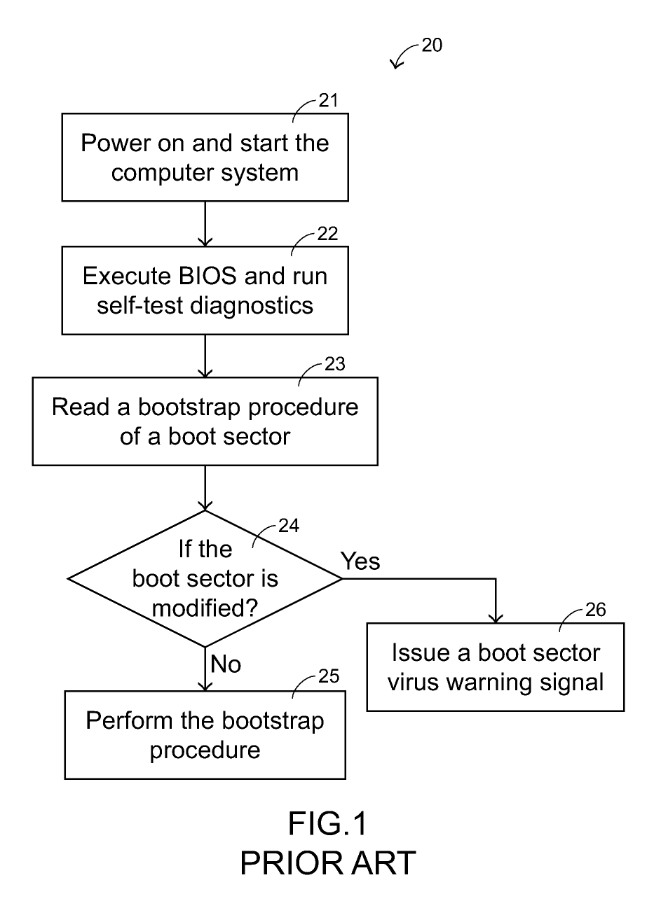

FIG. 2 is a schematic functional block diagram illustrating a device for preventing virus infection of a hard disk according to a preferred embodiment of the present invention; and

FIG. 3 is a flowchart illustrating a method for preventing virus infection of a hard disk according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

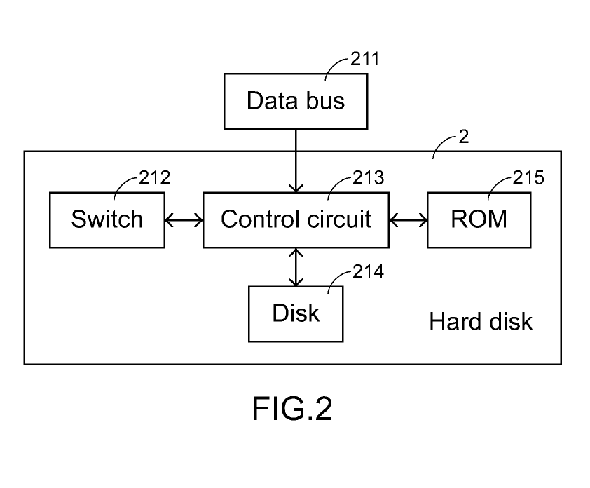

FIG. 2 is a schematic functional block diagram illustrating a device for preventing virus infection of a hard disk according to a preferred embodiment of the present invention. The virus infection preventing device is included in a hard disk 2. As shown in FIG. 2, the virus infection preventing device principally comprises a control circuit 213, a switch 212, a read-only memory (ROM) 215 and a disk (storage media) 214. In this embodiment, an exemplary storage media 214 is a disk. The control circuit 213 is communicated with the switch 212, the disk 214 and the read-only memory 215. The control circuit 213 is manipulated by the firmware that is stored in the read-only memory 215.

Please refer to FIG. 2 again. The hard disk 2 is connected to a data bus 211. For executing a write command, a host firstly issues the write command to the hard disk 2 through the data bus 211. Under manipulation of the firmware stored in the read-only memory 215, the control circuit 213 will discriminate whether the write command allows data to be written into the disk 214 or not. In accordance with a key feature of the present invention, if the firmware recognizes that a write address of the write command corresponds to the boot sector of the disk 214, the firmware will manipulate the control circuit 213 to detect a control signal generated by the switch 212. The control signal is then transmitted to the firmware through the control circuit 213. According to the control signal, the firmware will discriminate whether the write command is executed to write data into the boot sector or not.

The switch 212 is communicated with the control circuit 213. The switch 212 can generate the control signal. Depending on different types of the control signal, the function of writing data into the boot sector of the disk 214 is selectively enabled or disabled. In other words, the firmware can discriminate whether the function of writing data into the boot sector is enabled or disabled. The control signal includes a first signal and a second signal. If the switch 212 is turned on, the first signal is generated by the switch 212 to indicate that the function of writing data into the boot sector is disabled. Whereas, if the switch 212 is turned off, the second signal is generated by the switch 212 to indicate that the function of writing data into the boot sector is enabled.

For example, in a case that the operating system needs to be re-installed, a write command whose write address corresponds to the boot sector of the disk 214 will be issued to the control circuit 213 of the hard disk 2 through the data bus 211. Under manipulation of the firmware stored in the read-only memory 215, the control circuit 213 will discriminate whether the write command is executed to write a data into the disk 214 or not. That is, the firmware will manipulate the control circuit 213 to detect a control signal generated by the switch 212. The control signal is then transmitted to the firmware through the control circuit 213. According to the control signal, the firmware will discriminate whether the write command is executed to write data into the boot sector or not. For re-installing the operating system, the user needs to turn off the switch 212 and thus a second signal is issued from the switch 212 to the control circuit 213. The second signal indicates that the function of writing data into the boot sector is enabled. The second signal is then transmitted to the firmware through the control circuit 213. After the second signal is received, the firmware will manipulate the control circuit 213 to execute the write command so as to write data into the boot sector of the disk 214.

On the other hand, after the operating system has been installed, the user needs to turn on the switch 212 and thus a first signal is issued from the switch 212 to the control circuit 213. The first signal indicates that the function of writing data into the boot sector is disabled. The first signal is then transmitted to the firmware through the control circuit 213. After the first signal is received, the firmware will manipulate the control circuit 213 to abort execution of the write command for allowing data to be written into a boot sector of the hard disk 214. At the same time, this unexpected event associated with the non-executive writing command is recorded in the disk 214.

In accordance with a key feature of the present invention, the read-only memory 215 has specified control software with an S.M.A.R.T. (Self-Monitoring, Analysis and Reporting Technology) function. S.M.A.R.T. is a monitoring system for the hard disk to self-detect, analyze and report on various indicators of reliability. This specified control software will periodically read the disk 214 to realize whether any unexpected event associated with the non-executive writing command is recorded in the disk 214. If any unexpected event associated with the non-executive writing command is read by the control software, a message relating to the unexpected event is immediately shown to notify the user that an unexpected writing operation on the boot sector has occurred. According to this message, the user can discriminate whether the writing operation is normal. For example, during the process of re-installing the operating system, execution of the write command to write data into the boot sector is necessary so that the user needs to turn off the switch 212. As such, the control signal is switched from the first signal to the second signal so as to enable the function of writing data into the boot sector and successfully install the operating system. On the other hand, if the message denotes an unexpected event associated with the non-executive writing command, it is meant that some viruses try to attack the boot sector. Meanwhile, the user may immediately perform the virus-scanning operation and update the anti-virus software.

An exemplary pseudo code for the firmware to discriminate whether the write command is executed to write data into the boot sector will be illustrated as follows:

| If(Write LBA 0 or CHS=0:0:1); | |
|---|---|
| If(AntiVirusEn) | |
| { | Command Abort; |
| | Record event into SMART Log; |
| | Return fail;} |

According to the pseudo code, the firmware begins the discrimination when the write command is transmitted to the control circuit 213 through the data bus 211. If the write command allows data to be written into the boot sector of the hard disk, the firmware will manipulate the control circuit 213 to detect the control signal issued from the switch 212. The control signal is then transmitted to the firmware through the control circuit 213. If the switch 212 is turned on, the first signal generated by the switch 212 is detected by the control circuit 213 and then transmitted to the firmware through the control circuit 213. After the first signal is received, the firmware will manipulate the control circuit 213 to abort execution of the write command for allowing data to be written into a boot sector of the hard disk 214. At the same time, this unexpected event associated with the non-executive writing command is recorded in the disk 214. Afterwards, the unexpected event recorded in the disk 214 is shown in real time by specified control software with the S.M.A.R.T. function, thereby notifying the user that an unexpected writing operation on the boot sector has occurred.

In some embodiments, the switch 212 is a hot key arranged on a peripheral device of the computer. For example, the switch 212 is a hot key arranged on a keyboard of a notebook computer. This hot key is activated or inactivated to enable or disable the function of writing data into the boot sector. For example, when the hot key is depressed at the first time, the function of writing data into the boot sector is disabled. When the hot key is depressed at the second time, the function of writing data into the boot sector is enabled. Alternatively, the switch 212 is a physic switch device arranged on the main body of the hard disk. This physic switch device may be switched between an ON state and an OFF state to generate either the first signal or the second signal. For example, when the physic switch device is turned on, the first signal is generated and thus the function of writing data into the boot sector is disabled. Whereas, when the physic switch device is turned off, the second signal is generated and thus the function of writing data into the boot sector is enabled.

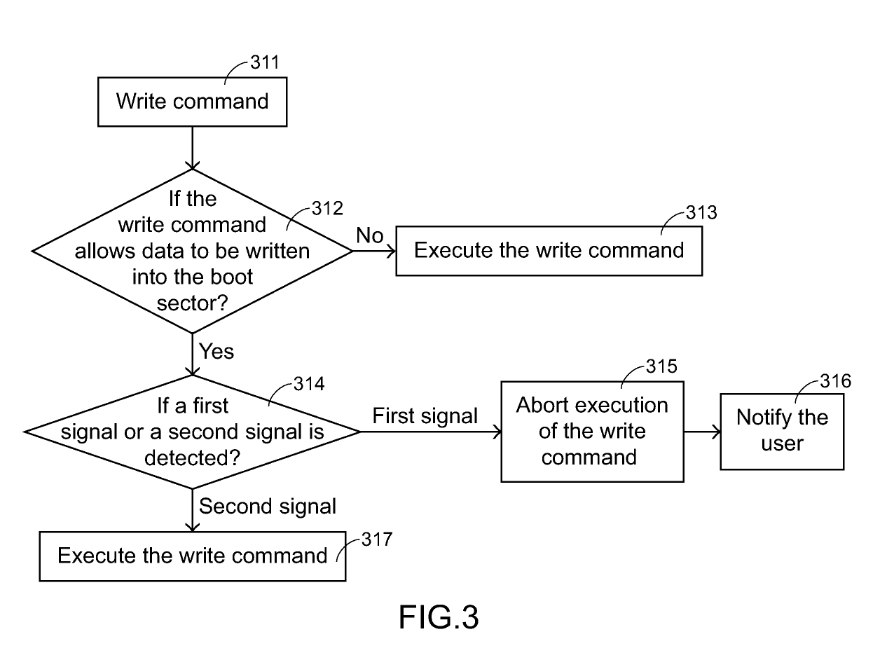

FIG. 3 is a flowchart illustrating a method for preventing virus infection of a hard disk according to the present invention. In this embodiment, a process of executing a write command is illustrated. First of all, a write command is issued (Step 311). When the write command is received by the hard disk 2, the firmware will discriminate whether the write command allows data to be written into the boot sector of the disk (Step 312). If the write command does not allow data to be written into the boot sector, the firmware will manipulate the control circuit 213 to execute the write command (Step 313). Whereas, if the write command allows data to be written into the boot sector, the firmware will manipulate the control circuit 213 to detect what kind of control signal is generated by the switch 212 (Step 314). The control signal is transmitted to the firmware through the control circuit 213. According to the control signal, the firmware will discriminate whether the write command is executed to write data into the boot sector.

If the switch 212 is turned off, a second signal is generated by the switch 212 and then detected by the control circuit 213. The second signal indicates that the function of writing data into the boot sector is enabled. The second signal is then transmitted to the firmware through the control circuit 213. After the second signal is received, the firmware allows the control circuit 213 to execute the write command to write data into the boot sector (Step 317). On the other hand, if the switch 212 is turned on, a first signal is generated by the switch 212 and then detected by the control circuit 213. The first signal indicates that the function of writing data into the boot sector is disabled. The first signal is then transmitted to the firmware through the control circuit 213. After the first signal is received, the firmware allows the control circuit 213 to abort execution of the write command and this unexpected event associated with the non-executive writing command is recorded in the disk 214 (Step 315). Afterwards, the unexpected event recorded in the disk 214 is shown in real time by the specified control software with the S.M.A.R.T. function, thereby notifying the user that an unexpected writing operation on the boot sector has occurred (Step 316).

In the above embodiments, the storage media is illustrated by referring to a disk. Nevertheless, the storage media may be a flash memory with a relative larger memory capacity. In a case that a flash memory is used as the storage media, the flash memory needs to have a boot sector. Similarly, the virus infection preventing device and the virus infection preventing method of the present invention can prevent the boot strap sector viruses from being written into the boot sector of the flash memory.

From the above description, the present invention provides a device and a method for preventing virus infection of a hard disk. By controlling the switch to generate a first signal or a second signal, the function of writing data into a boot sector is disabled or enabled. Optionally, if abnormal write command for writing data into the boot sector is detected, the control software with the S.M.A.R.T. function will notify the user and thus the user may immediately perform the virus-scanning operation and update the anti-virus software. In other words, the present invention can prevent the boot strap sector viruses from infecting the hard disk in a hardware control manner. As a consequence, boot strap sector viruses fail to unlock the hardware control mechanism and the security of the computer system is enhanced.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for preventing virus infection of a hard disk, comprising steps of:
generating either a first signal or a second signal by a switch;
receiving a write command; and
aborting the write command if the write command allows data to be written into a boot sector of the hard disk and the first signal is generated by the switch, or executing the write command if the write command allows data to be written into the boot sector of the hard disk and the second signal is generated by the switch.

2. The method according to claim 1 wherein the switch is a control hot key that is switched to generate either the first signal or the second signal.

3. The method according to claim 1 further comprising a step of recording an unexpected event in a storage media if the write command is aborted.

4. The method according to claim 3 further comprising a step of showing the unexpected event in real time, when recording the unexpected event in the storage media.

5. The method according to claim 1 wherein the switch generates the second signal if an operating system is being installed.

6. A device for preventing virus infection of a hard disk, the device comprising:
a storage media;
a read-only memory storing a firmware therein;
a control circuit communicated with the read-only memory and the storage media and manipulated by the firmware; and
a switch communicated with the control circuit for issuing either a first signal or a second signal to the control circuit, wherein if a write command received by the control circuit allows data to be written into a boot sector of the storage media and the first signal is generated by the switch, the write command is aborted; and if the write command allows data to be written into the boot sector of the storage media and the second signal is generated by the switch, the write command is executed.

7. The device according to claim 6 wherein the switch is a control hot key that is switched to generate either the first signal or the second signal.

8. The device according to claim 6 wherein an unexpected event in the storage media if the write command is aborted.

9. The device according to claim 8 wherein the unexpected event is shown in real time, when recording the unexpected event in the storage media.

10. The device according to claim 6 wherein the storage media is a disk or a flash memory.

11. The device according to claim 6 wherein the switch generates the second signal if an operating system is being installed.
